(19) United States
(12) Patent Application Publication
(10) Pub. No.: US 2023/0289418 A1
(43) Pub. Date: Sep. 14, 2023

(54) AUTHENTICATION CONTROL APPARATUS, AUTHENTICATION CONTROL SYSTEM, AUTHENTICATION CONTROL METHOD, AND NONTRANSITORY COMPUTER-READABLE MEDIUM

(71) Applicant: NEC Corporation, Minato-ku, Tokyo (JP)

(72) Inventors: Honami Yuki, Tokyo (JP); Shuuji Kikuchi, Tokyo (JP); Takaya Fukumoto, Tokyo (JP); Kazuya Matsumoto, Tokyo (JP)

(73) Assignee: NEC Corporation, Minato-ku, Tokyo (JP)

(21) Appl. No.: 18/013,775

(22) PCT Filed: Jul. 1, 2020
(86) PCT No.: PCT/JP2020/025779

§ 371 Date: Dec. 29, 2022

(51) Int. Cl. G06F 21/32; G06T 5/50; G06V 40/16; G01J 5/48

(52) U.S. Cl. CPC G06F 21/32; G06T 5/50; G06V 40/171; G06V 40/172; G01J 5/48; G06T 2207/20221; G06T 2207/30201

(57) ABSTRACT

An authentication control apparatus (10) includes: an image acquisition unit (11) that acquires an image obtained by imaging a body including a face of an authentication target person; an authentication control unit (12) that acquires a face authentication result obtained using face feature information of a plurality of persons and face feature information extracted from the image; a body surface temperature acquisition unit (13) that acquires a body surface temperature measured from the authentication target person; a decision unit (14) that decides a display mode associated to a combination of the face authentication result and the body surface temperature; and an output unit (15) that outputs the image to a predetermined display device according to the decided display mode.

### TECHNICAL FIELD

The present invention relates to an authentication control apparatus, an authentication control system, an authentication control method, and a non-transitory computer-readable medium, and more particularly to an authentication control apparatus, an authentication control system, an authentication control method, and a non-transitory computer-readable medium for controlling biometric authentication.

### BACKGROUND ART

In a facility that permits a person having entrance qualification to enter, a gate device installed at an entrance performs authentication for a person who wishes to enter, and controls opening and closing of a gate according to the authentication result. At this time, a biometric authentication technology such as face authentication or vein authentication is increasingly used to determine entrance qualification. Here, Patent Literature 1 discloses a technology related to an authentication system that performs face authentication and vein authentication. Patent Literature 2 discloses a technology related to a security system for individually giving fine passage authority to an entering person at the time of entrance. Patent Literature 3 discloses a technology of detecting a face region of a person included in an image, calculating a face feature amount of the detected face region, comparing the calculated face feature amount with a face feature amount stored in storage means, and recognizing the person having the face region based on the comparison result.

In addition, from the viewpoint of preventing the spread of infectious diseases, not only collation with information registered in advance but also confirmation of a health condition of a person at the time of entrance has been increasingly performed for determination of entrance qualification. Patent Literature 4 discloses a technology related to an imaging system capable of simultaneously capturing a visible image and an infrared image of a specific person, recognizing a face of the person in the visible image, and measuring vital signs such as pulse and body temperature from the infrared image of a skin region of the face.

### CITATION LIST

### Patent Literature

Patent Literature 1: Japanese Unexamined Patent Application Publication No. 2019-128880
Patent Literature 2: Japanese Unexamined Patent Application Publication No. 2017-224186
Patent Literature 3: Japanese Unexamined Patent Application Publication No. 2009-267783
Patent Literature 4: Japanese Unexamined Patent Application Publication No. 2016-103786

### SUMMARY OF INVENTION

### Technical Problem

In recent years, there has been an increasing need to collectively confirm an authentication result and a health condition of a person who wishes to enter at the time of entrance. However, in Patent Literatures described above, there is a problem that it is difficult to intuitively visually recognize the authentication result and the health condition.

The present disclosure has been made to solve such a problem, and an object of the present disclosure is to provide an authentication control apparatus, an authentication control system, an authentication control method, and a non-transitory computer-readable medium that enable intuitive visual recognition of an authentication result and a health condition.

### Solution to Problem

An authentication control apparatus according to a first aspect of the present disclosure includes:
image acquisition means for acquiring an image obtained by imaging a body including a face of an authentication target person;
authentication control means for acquiring a face authentication result obtained using face feature information of a plurality of persons and face feature information extracted from the image;
body surface temperature acquisition means for acquiring a body surface temperature measured from the authentication target person;
decision means for deciding a display mode associated to a combination of the face authentication result and the body surface temperature; and
output means for outputting the image to a predetermined display device according to the decided display mode.

An authentication control system according to a second aspect of the present disclosure includes:
an imaging device;
a body surface temperature measurement device;
a display device; and
an authentication control apparatus,
in which the authentication control apparatus includes:
image acquisition means for acquiring an image obtained by imaging, by the imaging device, a body including a face of an authentication target person;
authentication control means for acquiring a face authentication result obtained using face feature information of a plurality of persons and face feature information extracted from the image;
body surface temperature acquisition means for acquiring a body surface temperature of the authentication target person measured by the measurement device;
decision means for deciding a display mode associated to a combination of the face authentication result and the body surface temperature; and
output means for outputting the image to the display device according to the decided display mode.

An authentication control method according to a third aspect of the present disclosure performed by a computer includes:
acquiring an image obtained by imaging a body including a face of an authentication target person;
acquiring a face authentication result obtained using face feature information of a plurality of persons and face feature information extracted from the image;
acquiring a body surface temperature measured from the authentication target person;
deciding a display mode associated to a combination of the face authentication result and the body surface temperature; and
outputting the image to a predetermined display device according to the decided display mode.

A non-transitory computer-readable medium storing an authentication control program according to a fourth aspect of the present disclosure causes a computer to perform:
image acquisition processing of acquiring an image obtained by imaging a body including a face of an authentication target person;
authentication control processing of acquiring a face authentication result obtained using face feature information of a plurality of persons and face feature information extracted from the image;
determination processing of acquiring a body surface temperature measured from the authentication target person;
selection processing of deciding a display mode associated to a combination of the face authentication result and the body surface temperature;
and output processing of outputting the image to a predetermined display device according to the decided display mode.

### Advantageous Effects of Invention

According to the present disclosure, it is possible to provide the authentication control apparatus, the authentication control system, an authentication control method, and the non-transitory computer-readable medium that enable intuitive visual recognition of an authentication result and a health condition.

### BRIEF DESCRIPTION OF DRAWINGS

FIG. 1 is a block diagram illustrating a configuration of an authentication control apparatus according to a first example embodiment.

FIG. 2 is a flowchart illustrating a flow of an authentication control method according to the first example embodiment.

FIG. 3 is a block diagram illustrating an overall configuration of an authentication control system according to a second example embodiment.

FIG. 4 is a block diagram illustrating a configuration of an authentication apparatus according to the second example embodiment.

FIG. 5 is a flowchart illustrating a flow of face information registration processing according to the second example embodiment.

FIG. 6 is a flowchart illustrating a flow of face authentication processing performed by the authentication apparatus according to the second example embodiment.

FIG. 7 is a block diagram illustrating a configuration of an authentication control apparatus according to the second example embodiment.

FIG. 8 is a flowchart illustrating a flow of an authentication control method according to the second example embodiment.

FIG. 9 is a diagram illustrating an example of a display mode according to the second example embodiment.

FIG. 10 is a diagram illustrating an example of arrangement of a mirror signage according to the second example embodiment.

FIG. 11 is a block diagram illustrating a configuration of an authentication control apparatus according to a third example embodiment.

FIG. 12 is a flowchart illustrating a flow of an authentication control method according to the third example embodiment.

FIG. 13 is a diagram illustrating an example of a display mode according to the third example embodiment.

FIG. 14 is a diagram illustrating a display example of a body surface temperature and a measurement reason according to the third example embodiment.

FIG. 15 is a block diagram illustrating a configuration of an authentication control apparatus according to a fourth example embodiment.

FIG. 16 is a flowchart illustrating a flow of an authentication control method according to the fourth example embodiment.

FIG. 17 is a block diagram illustrating a configuration of an authentication control apparatus according to a fifth example embodiment.

FIG. 18 is a flowchart illustrating a flow of an authentication control method according to the fifth example embodiment.

### EXAMPLE EMBODIMENT

Hereinafter, example embodiments of the present disclosure will be described in detail with reference to the drawings. In the drawings, the same or corresponding elements are denoted by the same reference signs, and an overlapping description is omitted as necessary for clarity of description.

### First Example Embodiment

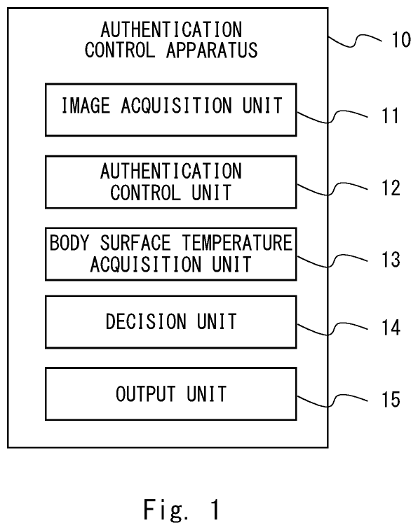

FIG. 1 is a block diagram illustrating a configuration of an authentication control apparatus 10 according to a first example embodiment. The authentication control apparatus 10 is an information processing apparatus that performs personal authentication and measurement of a body surface temperature of a person imaged by an imaging device (not illustrated) at the time of entering a facility or the like, and outputs the results to a display device (not illustrated) in a display mode associated to a combination of the results. Here, the authentication control apparatus 10 is connected to a network (not illustrated). The network may be a wired network or a wireless network. In addition, the network is connected to the imaging device, a body surface temperature measurement device (not illustrated), and the display device installed at an entrance of the facility or the like. The imaging device and the body surface temperature measurement device may be integrated. The display device may be a mirror signage or the like.

The authentication control apparatus 10 includes an image acquisition unit 11, an authentication control unit 12, a body surface temperature acquisition unit 13, a decision unit 14, and an output unit 15. The image acquisition unit 11 acquires an image obtained by imaging, by the imaging device, a body including a face of an authentication target person. The authentication control unit 12 acquires a face authentication result obtained using face feature information of a plurality of persons and face feature information extracted from the acquired image. In a case where the face feature information of a plurality of persons is stored in advance in the authentication control apparatus 10, the authentication control unit 12 performs authentication processing. Alternatively, in a case where the face feature information of a plurality of persons is stored in advance in an authentication apparatus outside the authentication control apparatus 10, the authentication control unit 12 causes the authentication apparatus to perform authentication and acquires the authentication result. The body surface temperature acquisition unit 13 acquires a body surface temperature measured from the authentication target person by the measurement device described above. The decision unit 14 decides a display mode associated to a combination of the face authentication result and the body surface temperature. The display mode includes a display content, a display method, and the like. The decision unit 14 may decide one or more display modes by selecting from among a plurality of different display modes. The display mode may be, for example, a combination of an indication of success or failure in the face authentication result and an indication of the body surface temperature. Alternatively, the display mode may be a combination of the indication of success or failure in the face authentication result and an indication, color, pattern, or the like showing a result of determination as to whether or not the body surface temperature is lower than a predetermined value. Alternatively, the display mode may be a total of four patterns that are a combination of two patterns of success and failure in the face authentication result and two patterns of success and failure in the determination result. Alternatively, the display mode may be a total of three patterns including two patterns of success and failure in the determination result in a case where the face authentication result indicates success and one pattern in a case where the face authentication result indicates failure. The output unit 15 outputs the image to a predetermined display device according to the decided display mode.

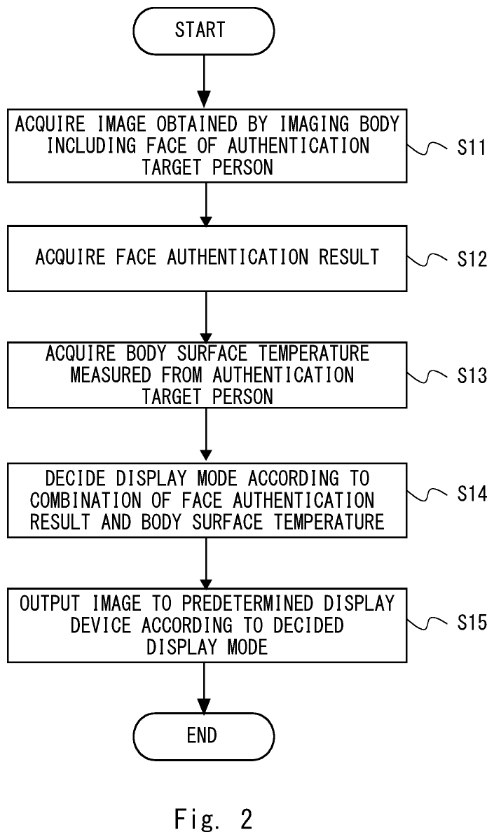

FIG. 2 is a flowchart illustrating a flow of an authentication control method according to the first example embodiment. First, the image acquisition unit 11 acquires an image obtained by imaging a body including a face of an authentication target person (S11). Next, the authentication control unit 12 acquires a face authentication result obtained using face feature information of a plurality of persons and face feature information extracted from the image acquired in step S11 (S12). The body surface temperature acquisition unit 13 acquires a body surface temperature measured from the authentication target person (S13). Then, the decision unit 14 decides a display mode associated to a combination of the face authentication result and the body surface temperature (S14). Thereafter, the output unit 15 outputs the image to a predetermined display device according to the decided display mode (S15).

As described above, according to the present example embodiment, an authentication result and a health condition are collectively displayed. Therefore, an authentication target person himself or herself, a security guard or the like around the display device can intuitively visually recognize the authentication result and the health condition.

Note that the authentication control apparatus 10 includes a processor, a memory, and a storage device as components not illustrated. Furthermore, the storage device stores a computer program in which processing of an image providing method according to the present example embodiment is implemented. Then, the processor reads the computer program from the storage device into the memory, and executes the computer program. As a result, the processor implements the functions of the image acquisition unit 11, the authentication control unit 12, the body surface temperature acquisition unit 13, the decision unit 14, and the output unit 15.

Alternatively, each of the image acquisition unit 11, the authentication control unit 12, the body surface temperature acquisition unit 13, the decision unit 14, and the output unit 15 may be implemented by dedicated hardware. In addition, some or all of the components of each device may be implemented by a general-purpose or dedicated circuitry, a processor, or the like, or a combination thereof. These may be implemented by a single chip or may be implemented by a plurality of chips connected via a bus. Some or all of the components of each device may be implemented by a combination of the above-described circuit or the like and a program. Furthermore, a central processing unit (CPU), a graphics processing unit (GPU), a field-programmable gate array (FPGA), or the like can be used as the processor.

Furthermore, in a case where some or all of the components of the authentication control apparatus 10 are implemented by a plurality of information processing apparatuses, circuits, and the like, the plurality of information processing apparatuses, circuits, and the like may be arranged in a centralized manner or in a distributed manner. For example, the information processing apparatuses, the circuits, and the like may be implemented in a form in which each of them is connected via a communication network, such as a client server system or a cloud computing system. Furthermore, the function of the authentication control apparatus 10 may be provided in a software as a service (SaaS) format.

### Second Example Embodiment

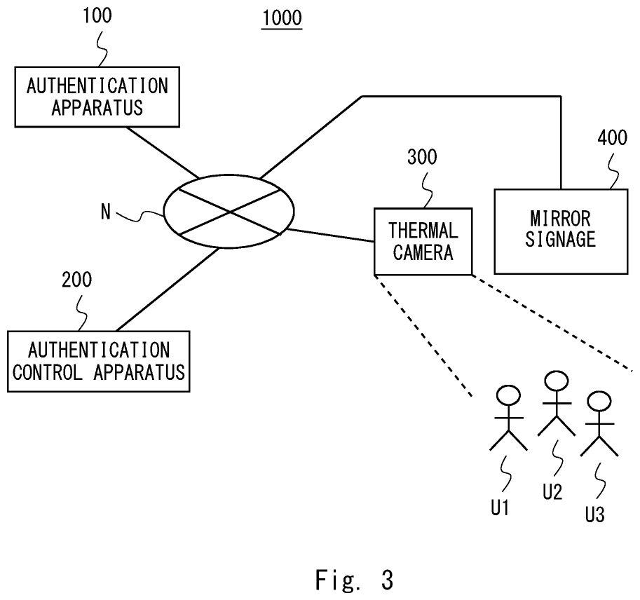

A second example embodiment is a specific example of the first example embodiment described above. FIG. 3 is a block diagram illustrating an overall configuration of an authentication control system 1000 according to the second example embodiment. The authentication control system 1000 includes an authentication apparatus 100, an authentication control apparatus 200, a thermal camera 300, and a mirror signage 400. The authentication apparatus 100, the authentication control apparatus 200, the thermal camera 300, and the mirror signage 400 are connected via a network N. Here, the network N is a wired or wireless communication line.

The thermal camera 300 is an example of the predetermined imaging device and the body surface temperature measurement device, and is a device including these devices. The imaging device may be, for example, a stereo camera. The thermal camera 300 captures an image of bodies including faces of users U1, U2, and U3, and transmits the captured images to the authentication control apparatus 200 and the mirror signage 400 via the network N. The thermal camera 300 captures an image of whole bodies and upper bodies of the users U1, U2, and U3. In addition, the thermal camera 300 measures a temperature in an imaging target region, generates a thermographic image showing a temperature distribution, and transmits the thermographic image to the authentication control apparatus 200 via the network N.

The mirror signage 400 is an example of the predetermined display device. The mirror signage 400 displays a captured image received from the thermal camera 300 via the network N while horizontally inverting the captured image. By doing so, the mirror signage 400 can display the users U1, U2, and U3 that the mirror signage 400 faces like a mirror. Alternatively, the entire mirror signage 400 may be a half mirror, and a display device such as a display may be arranged on the back side of the half mirror. As a result, a body region and decoration information can be superimposed and displayed. Alternatively, the entire mirror signage 400 may be a half mirror, and a display may be arranged at an upper portion of the half mirror. For example, the display may be arranged in a region at a height of 100 cm from the bottom of the mirror signage 400, and display information (a face authentication result, a body surface temperature, a determination result, or the like) and decoration information may be generally displayed on an upper body portion of the body. Alternatively, the display may be arranged in a region at a height of 180 cm from the bottom of the mirror signage 400, and display information or decoration information may be displayed near the top of the head.

In addition, the mirror signage 400 displays decoration information and display information received from the authentication control apparatus 200 via the network N according to a designated display mode. For example, the mirror signage 400 displays decoration information associated to each user at a position corresponding to a region of each user in a captured image. For example, in a case where the decoration information is a line type or a color, the mirror signage 400 displays the decoration information in such a way as to surround the region of each user in the captured image.

The authentication apparatus 100 is an information processing apparatus that stores face feature information of a plurality of persons. In response to a face authentication request received from the outside, the authentication apparatus 100 collates a face image or face feature information included in the request with face feature information of each user, and transmits, as a response, the collation result (authentication result) to a request source.

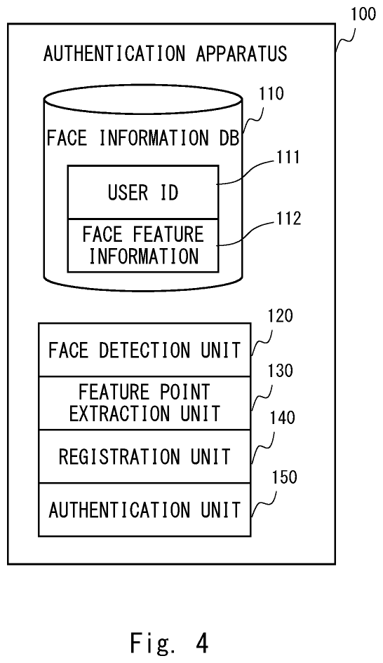

FIG. 4 is a block diagram illustrating a configuration of the authentication apparatus 100 according to the second example embodiment. The authentication apparatus 100 includes a face information database (DB) 110, a face detection unit 120, a feature point extraction unit 130, a registration unit 140, and an authentication unit 150. The face information DB 110 stores a user ID 111 and face feature information 112 of the user ID in association with each other. The face feature information 112 is a set of feature points extracted from a face image. Note that the authentication apparatus 100 may delete the face feature information 112 in the face feature DB 110 in response to a request from a user whose face feature information 112 is registered. Alternatively, the authentication apparatus 100 may delete the face feature information 112 after a lapse of a certain period from the registration of the face feature information.

The face detection unit 120 detects a face region included in a registration image for registering face information, and outputs the face region to the feature point extraction unit 130. The feature point extraction unit 130 extracts a feature point from the face region detected by the face detection unit 120, and outputs face feature information to the registration unit 140. In addition, the feature point extraction unit 130 extracts a feature point included in a face image received from the authentication control apparatus 200, and outputs face feature information to the authentication unit 150.

The registration unit 140 newly issues the user ID 111 when registering the face feature information. The registration unit 140 registers the issued user ID 111 and the face feature information 112 extracted from a registration image in association with each other in a face feature DB 110. The authentication unit 150 performs face authentication using the face feature information 112. Specifically, the authentication unit 150 collates face feature information extracted from a face image with the face feature information 112 in the face information DB 110. The authentication unit 150 transmits, as a response, whether or not the pieces of face feature information match each other to the authentication control apparatus 200. Whether or not the pieces of face feature information match each other corresponds to the success or failure of the authentication. A case where the pieces of face feature information match each other means a case where the degree of matching is equal to or higher than a predetermined value.

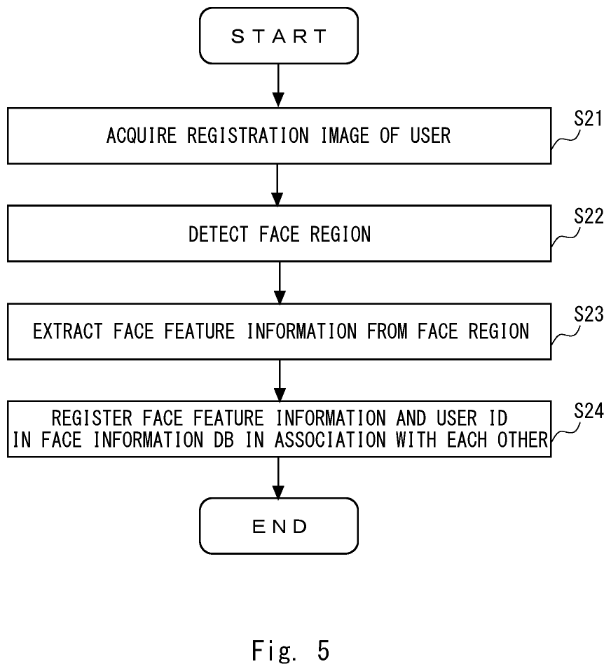

FIG. 5 is a flowchart illustrating a flow of face information registration processing according to the second example embodiment. Here, an information registration terminal (not illustrated) captures an image of a body including a face of each user, and transmits a face information registration request including the captured image (registration image) to the authentication apparatus 100 via the network N. The information registration terminal is, for example, an information processing apparatus such as a personal computer, a smartphone, or a tablet terminal.

First, the authentication apparatus 100 acquires the registration image included in the face information registration request (S21). For example, the authentication apparatus 100 receives the face information registration request from the information registration terminal via the network N. Next, the face detection unit 120 detects a face region included in the registration image (S22). Next, the feature point extraction unit 130 extracts a feature point from the face region detected in step S22 and outputs face feature information to the registration unit 140 (S23). Finally, the registration unit 140 issues the user ID 111, and registers the user ID 111 and the face feature information 112 in the face information DB 110 in association with each other (S24). The authentication apparatus 100 may receive the face feature information from the information registration terminal and register the face feature information 112 in the face information DB 110 in association with the user ID 111.

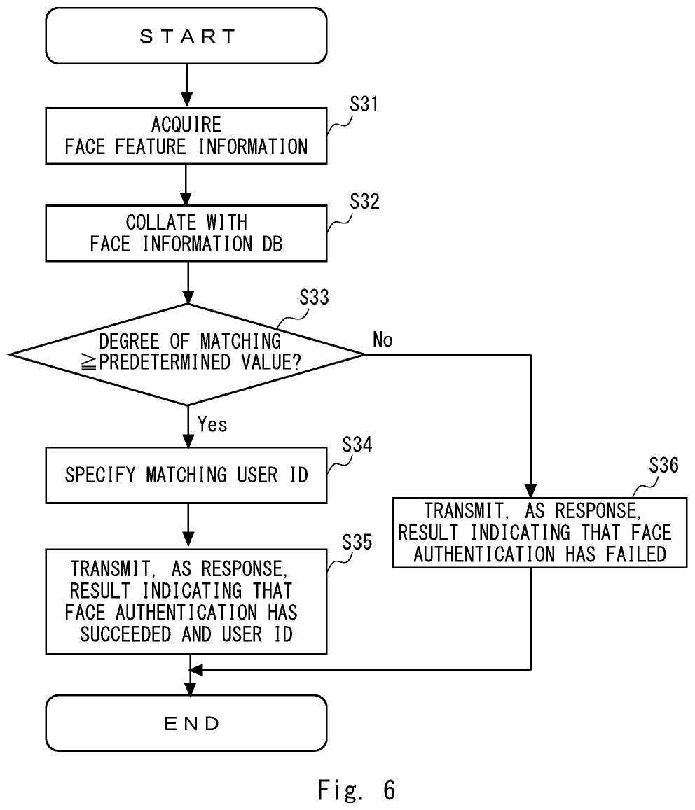

FIG. 6 is a flowchart illustrating a flow of face authentication processing performed by the authentication apparatus 100 according to the second example embodiment. First, the feature point extraction unit 130 acquires a face image for authentication included in a face authentication request (S31). For example, the authentication apparatus 100 receives the face authentication request from the authentication control apparatus 200 via the network N, and extracts face feature information from the face image included in the face authentication request as in steps S21 to S23. Alternatively, the authentication apparatus 100 may receive the face feature information from the authentication control apparatus 200. Next, the authentication unit 150 collates the acquired face feature information with the face feature information 112 in the face information DB 110 (S32). In a case where the pieces of face feature information match each other, that is, the degree of matching between the pieces of face feature information is equal to or higher than a predetermined value (Yes in S33), the authentication unit 150 specifies the user ID 111 of the user whose face feature information matches (S34), and transmits, as a response, a result indicating that face authentication has succeeded and the specified user ID 111 to the authentication control apparatus 200 (S35). In a case where there is no matching face feature information (No in S33), the authentication unit 150 transmits, as a response, a result indicating that the face authentication has failed to the authentication control apparatus 200 (S36).

In step S32, the authentication unit 150 does not need to attempt collation with all pieces of face feature information 112 in the face information DB 110. For example, the authentication unit 150 may preferentially attempt collation with face feature information registered in a period from a date of reception of the face authentication request to a date several days before the date of reception. As a result, a collation speed can be increased. In a case where the preferential collation has failed, it is sufficient if collation with all pieces of remaining face feature information is performed.

Returning to FIG. 3, the description will be continued. The authentication control apparatus 200 is an information processing apparatus that causes the mirror signage 400 to display decoration information obtained by combining face authentication results and body surface temperature determination results for the users U1 to U3 imaged and measured by the thermal camera 300 together with a captured image. The authentication control apparatus 200 may be redundant in a plurality of servers, and each functional block may be implemented by a plurality of computers.

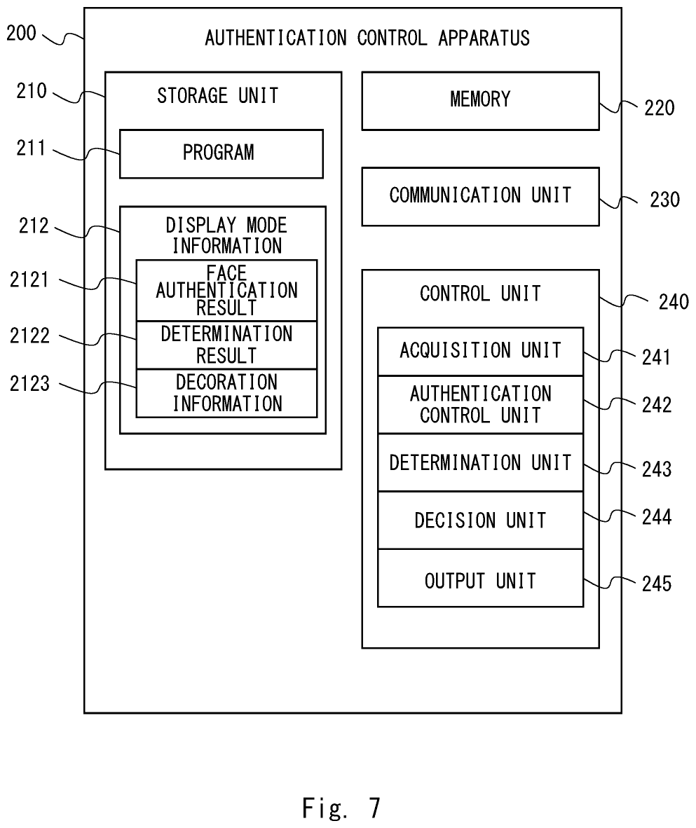

Next, the authentication control apparatus 200 will be described in detail. FIG. 7 is a block diagram illustrating a configuration of the authentication control apparatus 200 according to the second example embodiment. The authentication control apparatus 200 includes a storage unit 210, a memory 220, a communication unit 230, and a control unit 240. The storage unit 210 is a storage device such as a hard disk or a flash memory. The storage unit 210 stores a program 211 and display mode information 212. The program 211 is a computer program in which the processing of an authentication control method according to the second example embodiment is implemented.

The display mode information 212 is information defining a display mode. The display mode information 212 is information in which a face authentication result 2121, a determination result 2122, and decoration information 2123 are associated with each other. The decoration information 2123 is uniquely determined by a combination of the face authentication result 2121 and the determination result 2122. That is, the decoration information 2123 is an example of a display mode associated to a combination of the face authentication result 2121 and the body surface temperature determination result 2122. The face authentication result 2121 is a result indicating success or failure of face authentication for one user. The determination result 2122 is a result of determination (affirmative or negative) as to whether or not a measured value of a body surface temperature of one user is less than a predetermined value. The decoration information 2123 is a line type or a color. Specific examples of the definition of the display mode information 212 include the following (1) to (4).
(1) In a case where the face authentication result indicates success and the body surface temperature is lower than 37.5 degrees (the determination result is affirmative), the decoration information is green.
(2) In a case where the face authentication result indicates success and the body surface temperature is equal to or higher than 37.5 degrees (the determination result is negative), the decoration information is red.
(3) In a case where the face authentication result indicates failure and the body surface temperature is lower than 37.5 degrees (the determination result is affirmative), the decoration information is yellow.
(4) In a case where the face authentication result indicates failure and the body surface temperature is equal to or higher than 37.5 degrees (the determination result is negative), the decoration information is purple.

The decoration information may be common in (3) and (4).

The memory 220 is a volatile storage device such as a random access memory (RAM), and is a storage region for temporarily holding information during the operation of the control unit 240. The communication unit 230 is a communication interface with the network N.

The control unit 240 is a processor that controls each component of the authentication control apparatus 200, that is, a control device. The control unit 240 reads the program 211 from the storage unit 210 into the memory 220 and executes the program 211. As a result, the control unit 240 implements the functions of the acquisition unit 241, the authentication control unit 242, the determination unit 243, the decision unit 244, and the output unit 245.

The acquisition unit 241 is an example of the image acquisition unit 11 and the body surface temperature acquisition unit 13 described above. The acquisition unit 241 acquires a captured image and a thermographic image from the thermal camera 300 via the network N. The acquisition unit 241 collates the captured image with the thermographic image to acquire a body surface temperature of each user, for example, a temperature of a face. The acquisition unit 241 outputs the acquired captured image to the authentication control unit 242, and outputs the acquired body surface temperature to the determination unit 243.

The authentication control unit 242 is an example of the authentication control unit 12 described above. The authentication control unit 242 controls face authentication for the face regions of the users U1 to U3 included in the captured image. The authentication control unit 242 causes the authentication apparatus 100 to perform face authentication using face feature information extracted from a captured image for each user in the captured image acquired by the acquisition unit 241, and acquires a face authentication result from the authentication apparatus 100. Then, the authentication control unit 242 outputs the face authentication result of each user to the decision unit 244. For example, the authentication control unit 242 transmits a face authentication request including the acquired captured image to the authentication apparatus 100 via the network N, and receives a face authentication result of each user from the authentication apparatus 100. The authentication control unit 242 may detect the face regions of the users U1 to U3 from the captured image, include an image of the face region in the face authentication request for each user, and transmit the face authentication request. Alternatively, the authentication control unit 242 may extract face feature information from the face region and include the face feature information in the face authentication request.

The determination unit 243 determines whether or not the acquired body surface temperature is lower than a predetermined value. The determination unit 243 compares the body surface temperature of each user acquired by the acquisition unit 241 with a predetermined value (for example, 37.5 degrees), determines whether or not the body surface temperature is lower than the predetermined value, and outputs a determination result of each user to the decision unit 244. The determination result is “affirmative” in a case where the body surface temperature is lower than the predetermined value, and the determination result is “negative” in a case where the body surface temperature is equal to or higher than the predetermined value, but the determination result is not limited thereto.

The decision unit 244 is an example of the decision unit 14 described above. The decision unit 244 combines the face authentication result output from the authentication control unit 242 and the determination result output from the determination unit 243 for each user. That is, the decision unit 244 generates a combination of the face authentication result and the determination result of the user U1, a combination of the face authentication result and the determination result of the user U2, and a combination of the face authentication result and the determination result of the user U3. The decision unit 244 determines, as the display mode, decoration information associated to the combination for each user. Specifically, the decision unit 244 decides, for each user, the decoration information 2123 associated to a combination of the face authentication result and the determination result by selecting from the display mode information 212. In the above-described example, the decision unit 244 decides, as the decoration information, a line type or a color associated to the combination. In addition, the decision unit 244 decides display information associated to the face authentication result for each user. For example, in a case where the face authentication result indicates success, the decision unit 244 decides “F: OK” as the display information for the user. In a case where the face authentication result indicates failure, the decision unit 244 decides “F: NG” as the display information for the user. In addition, the decision unit 244 decides the display information associated to the body surface temperature or the determination result for each user. For example, the decision unit 244 may select an indication of the body surface temperature itself of each user as the display information. Alternatively, the decision unit 244 may select an indication of the determination result of the body surface temperature of each user as the display information. That is, it is sufficient if the decision unit 244 decides, as the display mode, the display information associated to at least one of the face authentication result and the body surface temperature or the determination result. For example, the display information is an indication of the face authentication result and the body surface temperature.

The output unit 245 is an example of the output unit 15 described above. The output unit 245 adds decided decoration information and display information to a captured image and transmits the captured image after the addition to the mirror signage 400 via the network N. That is, the output unit 245 outputs the captured image in such a way as to display the decided decoration information at a position corresponding to a region of each user in the captured image. Specifically, the output unit 245 outputs the captured image in such a way that a decided line type or color surrounds a region of each user. Furthermore, the output unit 245 outputs the captured image in such a way as to add and display decided display information at a position corresponding to a region of each user in the captured image.

Note that a region of a user in a captured image may be associated with decoration information and display information by collation between the captured image and a thermographic image as described above.

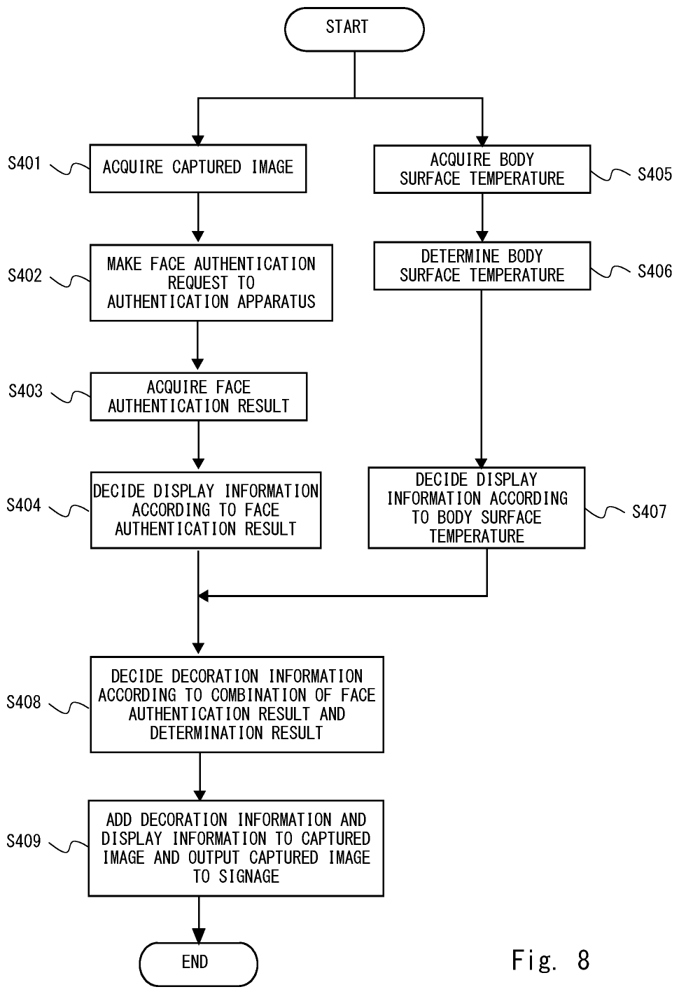

FIG. 8 is a flowchart illustrating a flow of the authentication control method according to the second example embodiment. Here, it is assumed that the users U1, U2, and U3 stand in front of the mirror signage 400. At this time, the thermal camera 300 captures an image of the users U1, U2, and U3, measures the temperatures, and generates a thermographic image. Then, the thermal camera 300 transmits the captured image and the thermographic image to the authentication control apparatus 200 via the network N.

Thus, the acquisition unit 241 acquires the captured image from the thermal camera 300 via the network N (S401). Then, the authentication control unit 242 makes a face authentication request to the authentication apparatus 100 for each user included in the captured image (S402). Specifically, the authentication control unit 242 extracts the face region of each user from the captured image, includes the face region in the face authentication request for each user, and transmits the face authentication request to the authentication apparatus 100 via the network N. Then, the authentication control unit 242 acquires the face authentication result for each user from the authentication apparatus 100 (S403). Thereafter, the decision unit 244 decides display information associated to the face authentication result for each user (S404).

In parallel with step S401, the acquisition unit 241 receives the thermographic image from the thermal camera 300 via the network N, collates the thermographic image with the captured image, and acquires the body surface temperature of the face region of each user (S405). Then, the determination unit 243 determines whether or not the body surface temperature is lower than a predetermined value for each user (S406). Thereafter, the decision unit 244 decides display information associated to the body surface temperature for each user (S407).

After steps S404 and S407, the decision unit 244 decides decoration information associated to a combination of the face authentication result and the determination result for each user (S408). Then, the output unit 245 adds the decoration information and the display information to the captured image and outputs the captured image after the addition to the mirror signage 400 via the network N (S409).

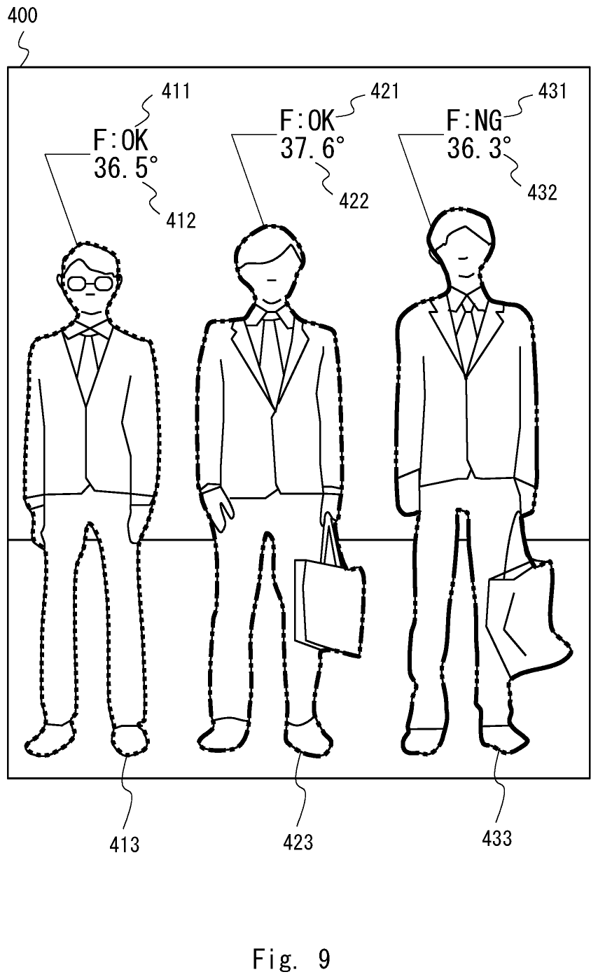

FIG. 9 is a diagram illustrating an example of a display mode according to the second example embodiment. Here, pieces of display information 411, 421, and 431 are pieces of display information associated to the face authentication result. The pieces of display information 412, 422, and 432 are pieces of display information associated to the body surface temperature. Note that the pieces of display information 412, 422, and 432 may be replaced with pieces of display information associated to the determination result. Furthermore, pieces of decoration information 413, 423, and 433 are pieces of decoration information associated to a combination of the face authentication result and the determination result. That is, for the user U1 on the left side, the face authentication result indicates success and the body surface temperature determination result is affirmative, and thus, a line type as the decoration information is a broken line. For the user U2 in the middle, the face authentication result indicates success and the body surface temperature determination result is negative, and thus, a line type as the decoration information is a line with alternating long and short dashes. For the user U3 on the right side, the face authentication result indicates failure and the body surface temperature determination result is affirmative, and thus, a line type as the decoration information is a line with alternating long and two short dashes. As described above, in the present example embodiment, a combination of the face authentication result and the determination result for each user can be intuitively identified by the decoration information. Furthermore, the identification is further facilitated by adding the display information to the region of each user.

In general, a gate device installed at an entrance of a facility controls opening and closing of a gate based on an authentication result of each person. In recent years, in order to cope with a large number of entering persons, it is required to make a gate-less device to continuously perform collective determination on a plurality of persons. Therefore, in the present example embodiment, the thermal camera 300 and the mirror signage 400 are installed as the gate-less devices, and the authentication control apparatus 200 and the authentication apparatus 100 perform authentication and determination of the body surface temperature, so that seamless entrance can be achieved.

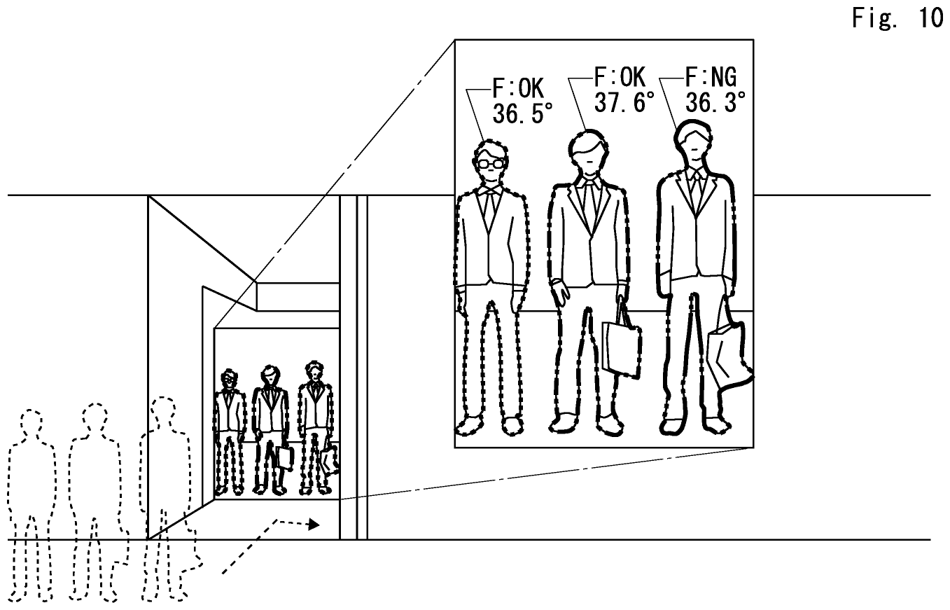

FIG. 10 is a diagram illustrating an example of arrangement of the mirror signage according to the second example embodiment. In FIG. 10, the mirror signage is arranged at a corner of a curved passage or the like. It is assumed that users proceed toward the mirror signage, and when the face authentication result indicates success and the determination result is affirmative, the users turn right and enter the facility. By arranging the mirror signage in a traveling direction of a user in this manner, the user can face the front side of the mirror signage and be subjected to face authentication. As the face authentication result and the determination result are displayed on the mirror signage in this manner, the user can easily recognize the face authentication result and the determination result. In addition, in a case where the face authentication result indicates failure or the determination result is negative, the user himself/herself can easily recognize the face authentication result or the determination result, and a nearby security guard can easily visually recognize the face authentication result or the determination result and speak to the user. In addition, as the face authentication result and the determination result are displayed in such a way as to surround the region of the user, the user himself/herself or the security guard can intuitively grasp the face authentication result and the determination result.

### Third Example Embodiment

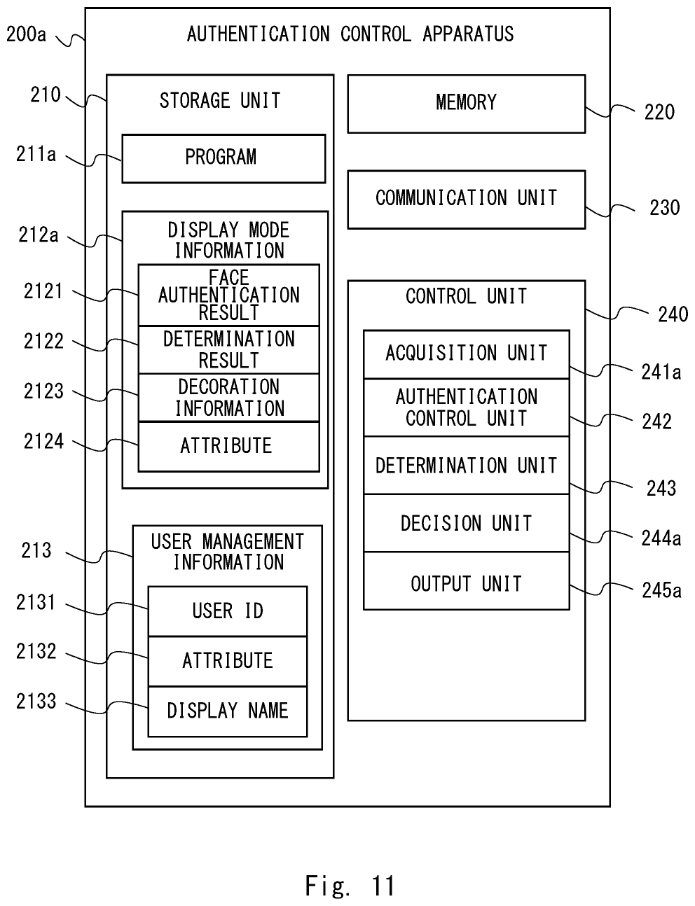

A third example embodiment is a modification of the second example embodiment described above. Note that an overall configuration of the third example embodiment is the same as that of FIG. 3, and thus illustration thereof is omitted, and differences will be described below. FIG. 11 is a block diagram illustrating a configuration of an authentication control apparatus 200a according to the third example embodiment. A storage unit 210 of the authentication control apparatus 200a is different from that of the authentication control apparatus 200 in that the program 211 and the display mode information 212 are replaced with a program 211a and display mode information 212a, and user management information 213 is added. A control unit 240 of the authentication control apparatus 200a is different from that of the authentication control apparatus 200 in that the acquisition unit 241, the decision unit 244, and the output unit 245 are replaced with an acquisition unit 241a, a decision unit 244a, and an output unit 245a. Other components are equivalent to those of the authentication control apparatus 200.

The program 211a is a computer program in which the processing of an authentication control method according to the third example embodiment is implemented.

The display mode information 212a is information in which an attribute 2124 is further associated with a face authentication result 2121, a determination result 2122, and decoration information 2123. That is, the decoration information 2123 is an example of a display mode associated to a combination of the face authentication result 2121, the determination result 2122, and the attribute 2124. The attribute 2124 is information indicating an attribute of a user, and is, for example, information indicating whether the user is an employee or a guest of an entrance target facility. Alternatively, the attribute 2124 may be gender, a position in the entrance target facility, or the like. Furthermore, the decoration information 2123 may be an image, for example, an image of a petal.

The user management information 213 is information for managing user information. The user management information 213 is information in which a user ID 2131, an attribute 2132, and a display name 2133 are associated with each other. The display name 2133 may be an indication for protecting privacy such as a nickname for the associated user ID 2131.

The acquisition unit 241a acquires an attribute of an authentication target person based on a face authentication result. For example, in a case where the face authentication result indicates success, the acquisition unit 241a specifies a user ID included in the face authentication result. Then, the acquisition unit 241a acquires the attribute 2132 associated with the specified user ID 2131 from the user management information 213.

The decision unit 244a decides a display mode further in association with the determined attribute. That is, the decision unit 244a decides the display mode (decoration information 2123) associated to a combination of the face authentication result 2121, the determination result 2122, and the attribute 2124 from the display mode information 212a. Note that the decision unit 244a may select a display mode (display information) associated to a combination of a face authentication result, a body surface temperature, and an attribute. The display information may be an indication of the face authentication result and the body surface temperature similarly to the second example embodiment. Alternatively, the display information may be an indication of the face authentication result and a body surface temperature determination result.

The output unit 245a outputs a captured image in such a way that the determined decoration information 2123 is superimposed on a region of each user in the captured image. Therefore, the mirror signage 400 displays an image associated to each user in such a way as to be superimposed on the region of each user in the captured image.

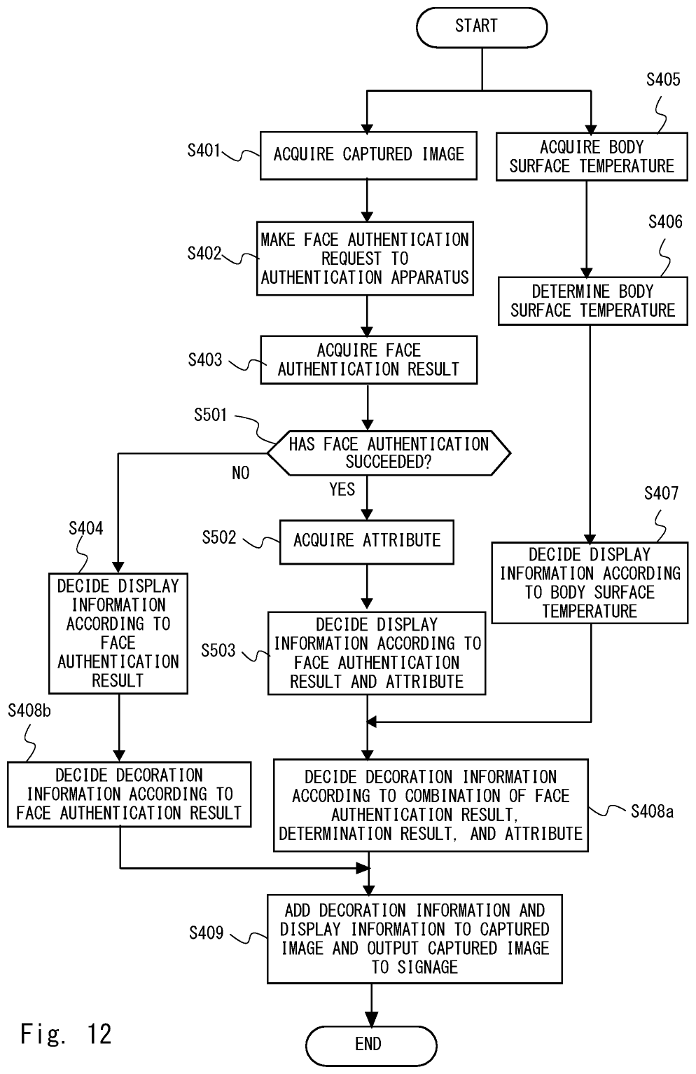

FIG. 12 is a flowchart illustrating a flow of an authentication control method according to the third example embodiment. Steps S401 to S403 and steps S405 to S407 are similar to those in FIG. 8 described above. After step S403, a determination unit 243 determines whether or not face authentication has succeeded (S501). Specifically, the determination unit 243 checks whether the acquired face authentication result indicates success or failure. Then, in a case where it is determined that the face authentication has failed, the decision unit 244a decides display information associated to the face authentication result for the user who has failed in the face authentication (S404). Examples of the display information include a “?” mark, and a message indicating a failure reason or urging retrying of the face authentication. The message indicating the failure reason is, for example, a message indicating that the face authentication has failed due to wearing of a mask. Subsequently, the decision unit 244a decides decoration information associated to the face authentication result for the user who has failed in the face authentication (S408b). Specifically, the decision unit 244a decides, from the display mode information 212a, the decoration information 2123 associated to a combination in which the face authentication result 2121 indicates failure and the determination result 2122 and the attribute 2124 are NULL.

In a case where it is determined in step S501 that the face authentication has succeeded, the acquisition unit 241a acquires the attribute of the user who has succeeded in the face authentication (S502). For example, the acquisition unit 241a acquires the attribute 2132 associated with a user ID included in the face authentication result from the user management information 213. In addition, the acquisition unit 241a may further acquire the display name 2133 associated with the user ID included in the face authentication result from the user management information 213.

Then, the decision unit 244a decides display information associated to the face authentication result and the attribute for the user who has succeeded in the face authentication (S503). For example, in a case where the attribute is guest, the decision unit 244a decides “Welcome” and the display name 2133 as the display information. Examples of the display information may include a check mark. In step S407, the decision unit 244a may select a measurement reason as the display information in addition to an indication of the body surface temperature.

After steps S503 and S407, the decision unit 244 determines decoration information associated to a combination of the face authentication result, the determination result, and the attribute for the user who has succeeded in the face authentication (S408). Specifically, the decision unit 244a decides, from the display mode information 212a, the decoration information 2123 associated with the combination of the face authentication result 2121, the determination result 2122, and the attribute 2124. For example, in a case where the face authentication result indicates success, the determination result is affirmative, and the attribute is guest, the decision unit 244a decides an image of a petal as the decoration information.

After steps S408a and S408b, the output unit 245a adds the decoration information and the display information to the captured image and outputs the captured image after the addition to the mirror signage 400 via the network N (S409).

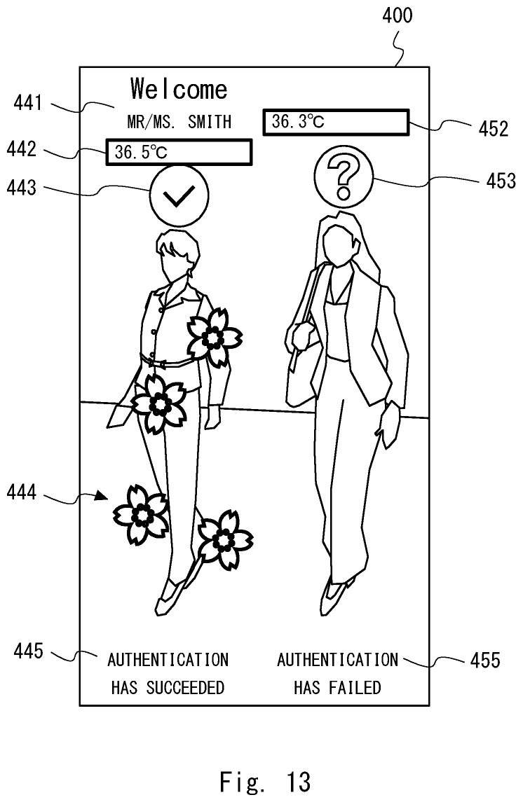

FIG. 13 is a diagram illustrating an example of a display mode according to the third example embodiment. Here, display information 441 is display information associated to a case where the face authentication result indicates success and the attribute is guest. Pieces of display information 443 and 445 are pieces of display information associated to a case where the face authentication result indicates success. Pieces of display information 442 and 452 are pieces of display information associated to a case where the determination result is affirmative. Pieces of display information 453 and 455 are pieces of display information associated to a case where the face authentication result indicates failure. Decoration information 444 is decoration information associated to a case where the face authentication result indicates success, the determination result is affirmative, and the attribute is guest. The decoration information 444 is an example in which an image of a petal is displayed in such a way as to be superimposed on a region of a user on the left side. Note that decoration information associated to any of a case where the face authentication result indicates failure, a case where the determination result is negative, and a case where the attribute is employee may be displayed. In addition, as display information associated to a case where the body surface temperature is equal to or higher than the predetermined value (the determination result is negative), for example, a message urging to go to an inspection chamber such as a message “to the inspection chamber” may be used. This makes it easy for not only a security guard but also an authentication target person to grasp a health condition of the authentication target person and move to the inspection chamber.

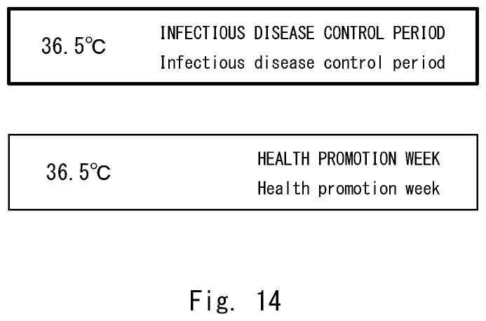

Note that the pieces of display information 442 and 452 may include a body surface temperature measurement reason in addition to the body surface temperature. FIG. 14 is a diagram illustrating a display example of the body surface temperature and the measurement reason according to the third example embodiment. Examples of the measurement reason include, but are not limited to, “infectious disease control period” (and its English notation) and “health promotion week” (and its English notation). This makes it easier for a user, particularly a guest, to grasp the reason why the body surface temperature has been measured.

As described above, in the present example embodiment, attribute information (affiliation or the like) of an authentication target person is held, and the attribute is determined when face authentication is performed. For example, a user may be determined as an employee if the user is affiliated, and a user may be determined as a guest if the user is not affiliated. Then, the display mode changes according to the attribute. For example, in a case of a guest, a “petal dancing” mode is adopted, but the display mode is not limited thereto. Therefore, according to the present example embodiment, in a case where a user is particularly a guest, a combination of the face authentication result and the determination result can be intuitively identified by the decoration information.

### Fourth Example Embodiment

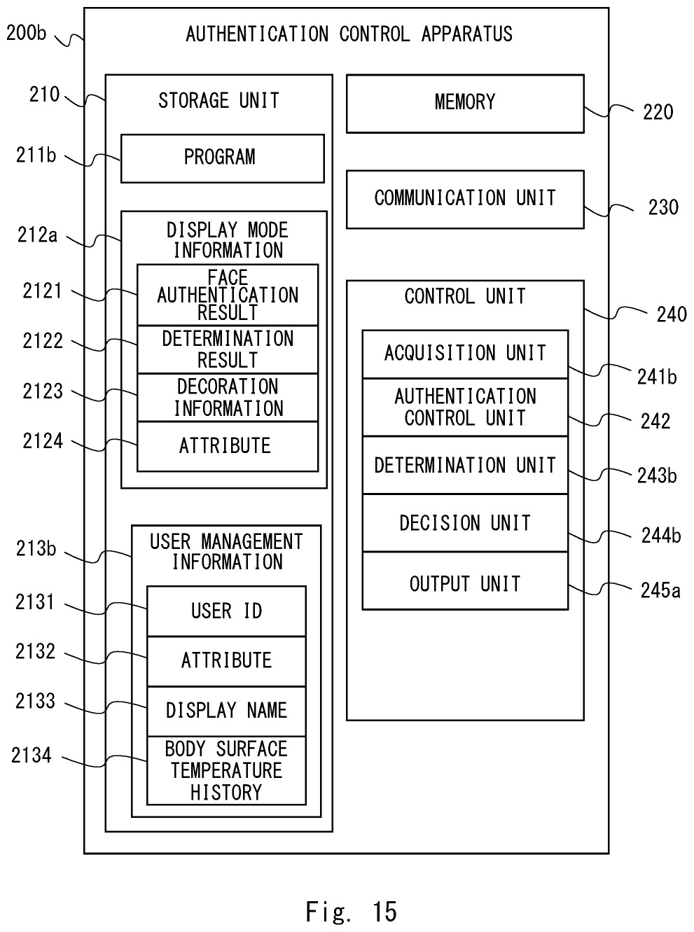

A fourth example embodiment is a modification of the second and third example embodiments described above. Note that an overall configuration of the fourth example embodiment is the same as that of FIG. 3, and thus illustration thereof is omitted, and differences will be described below. FIG. 15 is a block diagram illustrating a configuration of an authentication control apparatus 200b according to the fourth example embodiment. A storage unit 210 of the authentication control apparatus 200b is different from that of the authentication control apparatus 200a in that the program 211a and user management information 213 are replaced with a program 211b and user management information 213b. In addition, a control unit 240 of the authentication control apparatus 200b is different from that of the authentication control apparatus 200a in that the acquisition unit 241, the determination unit 243, and the decision unit 244a are replaced with an acquisition unit 241b, a determination unit 243b, and a decision unit 244b. Other components are equivalent to those of the authentication control apparatus 200a.

The program 211b is a computer program in which the processing of an authentication control method according to the fourth example embodiment is implemented.

The user management information 213b is information in which a body surface temperature history 2134 is further associated with a user ID 2131, an attribute 2132, and a display name 2133. The body surface temperature history 2134 is a measurement history of a body surface temperature of a corresponding user. For example, in a case where the attribute 2132 is employee, since the body surface temperature is measured by the thermal camera 300 every day, the body surface temperature history 2134 may be added to the user management information 213b in association with the user ID 2131 each time. The body surface temperature history 2134 may be an average value of measured values. For example, the average value may be calculated again each time the measurement is performed.

The acquisition unit 241b acquires a body surface temperature in a case where a face authentication result indicates success of face authentication. In this way, by suppressing acquisition of the body surface temperature when the face authentication has failed, the processing load of the authentication control apparatus 200b can be reduced.

The decision unit 244b decides a comparison target value (predetermined value) used by the determination unit 243b based on the body surface temperature history 2134 of each user. For example, a temperature one degree or more higher than the average value of the body surface temperature of the user is set as the predetermined value. The determination unit 243b determines the body surface temperature based on the determined predetermined value.

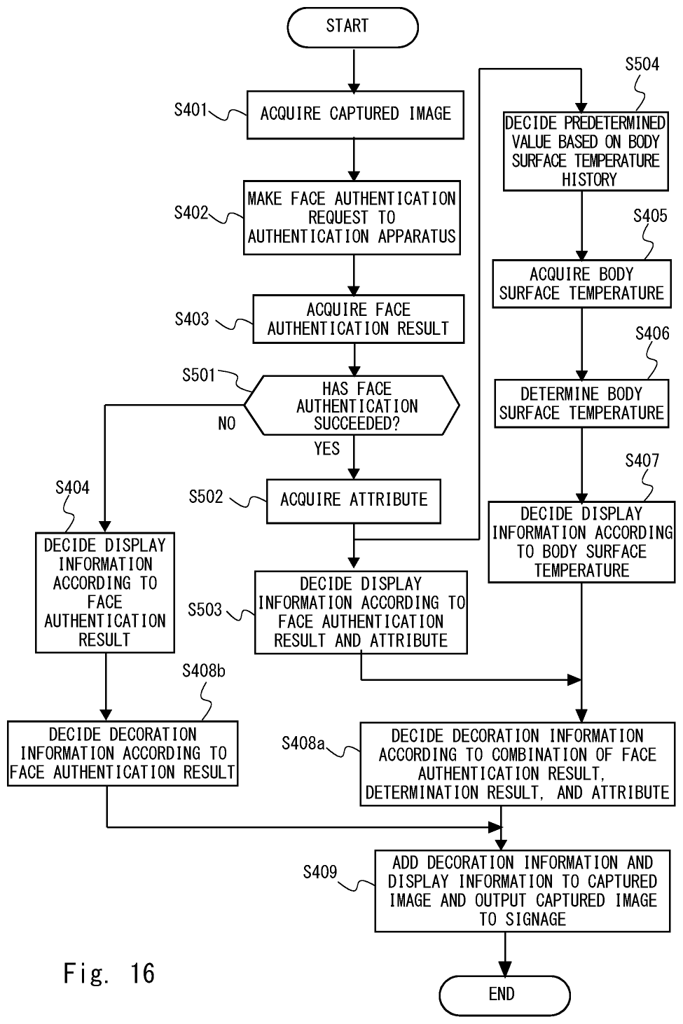

FIG. 16 is a flowchart illustrating a flow of an authentication control method according to the fourth example embodiment. Steps S401 to S502 are similar to those in FIG. 12 described above. After step S502, together with step S503, the decision unit 244b decides a predetermined value based on a body surface temperature history (S504). Specifically, the decision unit 244b calculates an average value of a body surface temperature for each user based on the body surface temperature history 2134, and decides a value obtained by adding one degree to the average value as the predetermined value. As a result, the comparison target value of the determination can be changed for each individual. Since the body surface temperature history 2134 is not registered for a guest, a preset value is set as the predetermined value as in the first to third example embodiments. However, the set value itself is variable.

Thereafter, the acquisition unit 241b acquires the body surface temperature (S405), and the determination unit 243b determines the body surface temperature by using the predetermined value for each user decided in step S504 (S406). The subsequent steps are similar to those in FIG. 12.

As described above, the same effects as those of the above-described example embodiments can be achieved by the present example embodiment. Furthermore, according to the present example embodiment, the comparison target value for the body surface temperature can be set to an appropriate value for the physical constitution of the user, and as a result of which, appropriate determination can be performed. The processing load can be reduced by acquiring the body surface temperature in a case where face authentication has succeeded.

### Fifth Example Embodiment

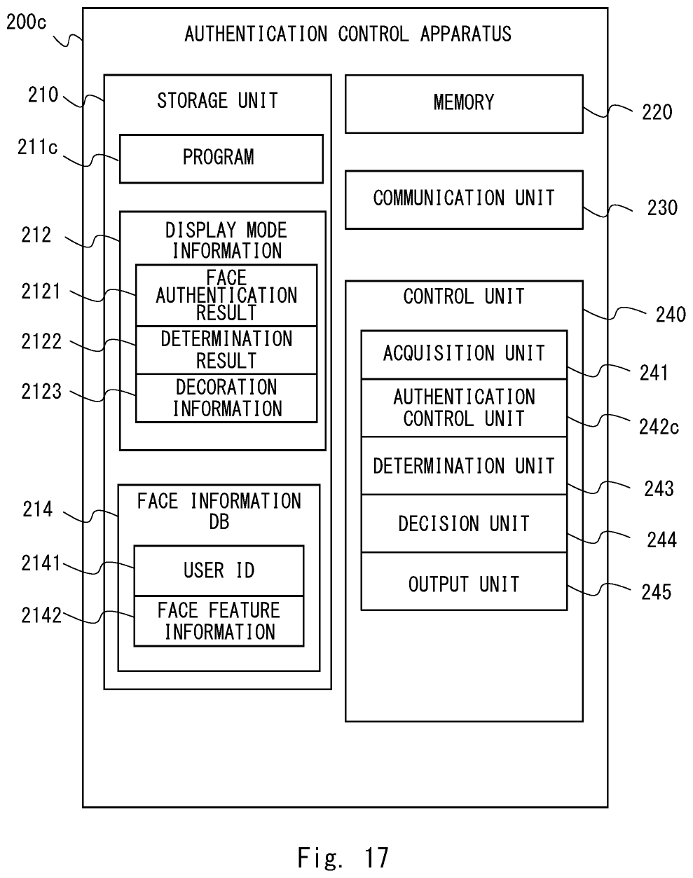

A fifth example embodiment is a modification of the second example embodiment described above. FIG. 17 is a block diagram illustrating a configuration of an authentication control apparatus according to the fifth example embodiment. A storage unit 210 of an authentication control apparatus 200c is different from that of the authentication control apparatus 200 described above in that the program 211 is replaced with a program 211c, and a face information DB 214 is added. In addition, a control unit 240 of the authentication control apparatus 200c is different from the authentication control apparatus 200 described above in that the authentication control unit 242 is replaced with an authentication control unit 242c.

The program 211c is a computer program in which the processing of an authentication control method according to the fifth example embodiment is implemented.

The face information DB 214 corresponds to the face information DB 110 of the authentication apparatus 100 described above, and a plurality of user IDs 2141 and face feature information 2142 are associated with each other.

The authentication control unit 242c collates face feature information extracted from a face region of a user included in an acquired captured image with the face feature information 2142 stored in the storage unit 210 to perform face authentication, thereby acquiring a face authentication result.

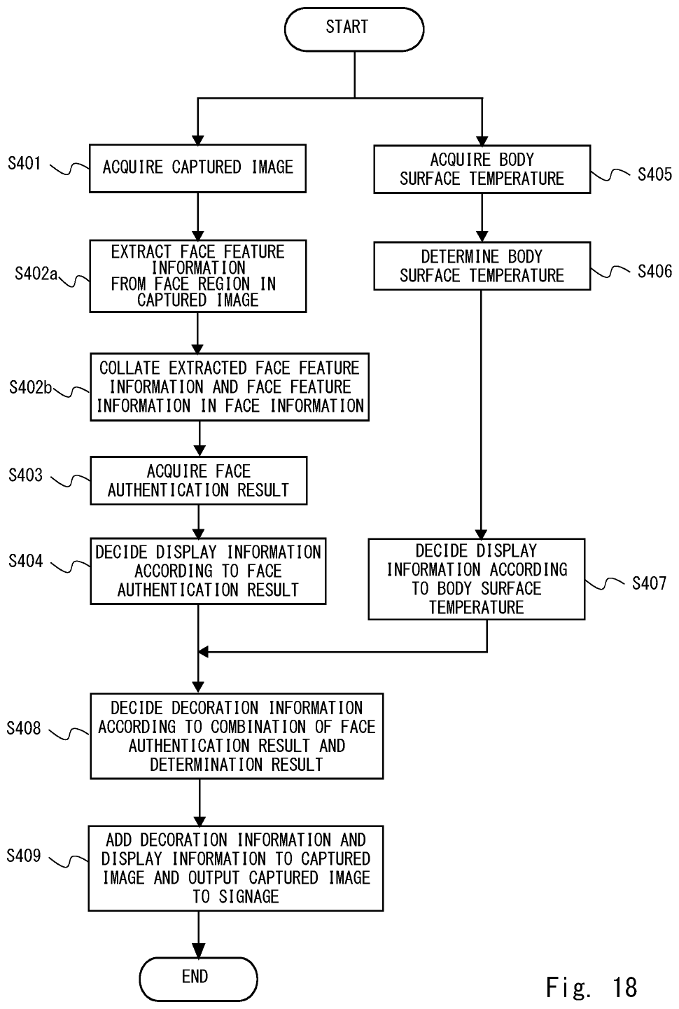

FIG. 18 is a flowchart illustrating a flow of an authentication control method according to the fifth example embodiment. In FIG. 18, step S402 in FIG. 8 described above is replaced with steps S402a and S402b.

After step S401, the authentication control unit 242c extracts face feature information from a face region of each user in an acquired captured image (S402a). Then, the authentication control unit 242b collates the extracted face feature information with the face feature information 2142 in the face information DB 214 for each user (S402b).

As described above, the same effects as those of the second example embodiment described above can be achieved by the fifth example embodiment. It goes without saying that the fifth example embodiment may be a modification of the third or fourth example embodiment.

### Other Embodiments and the Like

Note that, although the hardware configuration has been described in the above-described example embodiments, the present disclosure is not limited thereto. According to the present disclosure, arbitrary processing can also be implemented by causing a CPU to execute a computer program.

In the above example, the program may be stored using various types of non-transitory computer-readable media and supplied to a computer. The non-transitory computer-readable media include various types of tangible storage media. Examples of the non-transitory computer-readable medium include a magnetic recording medium (for example, a flexible disk, a magnetic tape, or a hard disk drive), an optical magnetic recording medium (for example, a magneto-optical disk), a compact disc-read only memory (CD-ROM), a CD-R, a CD-R/W, a digital versatile disc (DVD), and a semiconductor memory such as a mask ROM, a programmable ROM (PROM), an erasable PROM (EPROM), a flash ROM, or a random access memory (RAM). In addition, the program may be supplied to the computer by various types of transitory computer-readable media. Examples of the transitory computer-readable medium include an electric signal, an optical signal, and electromagnetic waves. The transitory computer-readable medium can provide the program to the computer via a wired communication line such as electric wires and optical fibers or a wireless communication line.

Note that the present disclosure is not limited to the above example embodiments, and can be appropriately changed without departing from the gist. Furthermore, the present disclosure may be implemented by appropriately combining the respective example embodiments.

Some or all of the above example embodiments may be described as the following supplementary notes, but are not limited to the following.

(Supplementary Note 1)

An authentication control apparatus including:
image acquisition means for acquiring an image obtained by imaging a body including a face of an authentication target person;
authentication control means for acquiring a face authentication result obtained using face feature information of a plurality of persons and face feature information extracted from the image;
body surface temperature acquisition means for acquiring a body surface temperature measured from the authentication target person;
decision means for deciding a display mode associated to a combination of the face authentication result and the body surface temperature; and
output means for outputting the image to a predetermined display device according to the decided display mode.

(Supplementary Note 2)

The authentication control apparatus according to Supplementary Note 1, further including determination means for determining whether or not the acquired body surface temperature is lower than a predetermined value, in which
the decision means decides, as the display mode, decoration information associated to a combination of the face authentication result and a body surface temperature determination result, and
the output means outputs the image in such a way as to display the decided decoration information at a position corresponding to a region of the authentication target person in the image.

(Supplementary Note 3)

The authentication control apparatus according to Supplementary Note 2, in which
the decision means decides a line type or a color associated to the combination of the face authentication result and the body surface temperature determination result as the decoration information, and
the output means outputs the image in such a way that a line of the decided line type or color surrounds the region of the authentication target person in the image.

(Supplementary Note 4)

The authentication control apparatus according to Supplementary Note 2, in which the output means outputs the image in such a way that the decided decoration information is superimposed on the region of the authentication target person in the image.

(Supplementary Note 5)

The authentication control apparatus according to any one of Supplementary Notes 2 to 4, in which
the decision means decides the predetermined value based on a body surface temperature history of the authentication target person, and
the determination means performs the determination based on the decided predetermined value.

(Supplementary Note 6)

The authentication control apparatus according to any one of Supplementary Notes 1 to 5, in which
the decision means decides display information associated to at least one of the face authentication result or the body surface temperature as the display mode, and
the output means outputs the image in such a way as to add and display the decided display information at a position corresponding to the region of the authentication target person in the image.

(Supplementary Note 7)

The authentication control apparatus according to Supplementary Note 6, in which the display information is an indication of the face authentication result and the body surface temperature.

(Supplementary Note 8)

The authentication control apparatus according to any one of Supplementary Notes 1 to 7, further including attribute acquisition means for acquiring an attribute of the authentication target person based on the face authentication result,
in which the decision means decides the display mode further in accordance with the acquired attribute.

(Supplementary Note 9)

The authentication control apparatus according to any one of Supplementary Notes 1 to 8,
in which the body surface temperature acquisition means acquires the body surface temperature in a case where the face authentication result indicates success of face authentication.

(Supplementary Note 10)

The authentication control apparatus according to any one of Supplementary Notes 1 to 9,
in which the predetermined display device is a mirror signage.

(Supplementary Note 11)

The authentication control apparatus according to any one of Supplementary Notes 1 to 10,
in which the authentication control means causes an authentication apparatus that stores the face feature information of the plurality of persons to perform the face authentication using the face feature information extracted from the image, and acquires the face authentication result from the authentication apparatus.

(Supplementary Note 12)

The authentication control apparatus according to any one of Supplementary Notes 1 to 10, further including storage means for storing the face feature information of the plurality of persons,
in which the authentication control means acquires the face authentication result by performing the face authentication by collating the face feature information of the plurality of persons with the face feature information extracted from the image.

(Supplementary Note 13)

An authentication control system including:
an imaging device;
a body surface temperature measurement device;
a display device; and
an authentication control apparatus,
in which the authentication control apparatus includes:
image acquisition means for acquiring an image obtained by imaging, by the imaging device, a body including a face of an authentication target person;
authentication control means for acquiring a face authentication result obtained using face feature information of a plurality of persons and face feature information extracted from the image;
body surface temperature acquisition means for acquiring a body surface temperature of the authentication target person measured by the measurement device;
decision means for deciding a display mode associated to a combination of the face authentication result and the body surface temperature; and
output means for outputting the image to the display device according to the decided display mode.

(Supplementary Note 14)

The authentication control system according to Supplementary Note 13, in which
the authentication control apparatus further includes determination means for determining whether or not the acquired body surface temperature is lower than a predetermined value,
the decision means decides, as the display mode, decoration information associated to a combination of the face authentication result and a body surface temperature determination result, and
the output means outputs the image in such a way as to display the decided decoration information at a position corresponding to a region of the authentication target person in the image.

(Supplementary Note 15)

An authentication control method performed by a computer, the authentication control method including:
acquiring an image obtained by imaging a body including a face of an authentication target person;
acquiring a face authentication result obtained using face feature information of a plurality of persons and face feature information extracted from the image;
acquiring a body surface temperature measured from the authentication target person;
deciding a display mode associated to a combination of the face authentication result and the body surface temperature; and
outputting the image to a predetermined display device according to the decided display mode.

(Supplementary Note 16)

A non-transitory computer-readable medium storing an authentication control program that causes a computer to perform:
image acquisition processing of acquiring an image obtained by imaging a body including a face of an authentication target person;
authentication control processing of acquiring a face authentication result obtained using face feature information of a plurality of persons and face feature information extracted from the image;
determination processing of acquiring a body surface temperature measured from the authentication target person;
selection processing of deciding a display mode associated to a combination of the face authentication result and the body surface temperature; and
output processing of outputting the image to a predetermined display device according to the decided display mode.

Although the present invention has been described with reference to the example embodiments (and examples), the present invention is not limited to the above example embodiments (and examples). Various modifications that can be understood by those skilled in the art can be made to the configuration and details of the present invention within the scope of the present invention.

### REFERENCE SIGNS LIST

10 AUTHENTICATION CONTROL APPARATUS
11 IMAGE ACQUISITION UNIT
12 AUTHENTICATION CONTROL UNIT
13 BODY SURFACE TEMPERATURE ACQUISITION UNIT
14 DECISION UNIT
15 OUTPUT UNIT
1000 AUTHENTICATION CONTROL SYSTEM
100 AUTHENTICATION APPARATUS
110 FACE INFORMATION DB
111 USER ID
112 FACE FEATURE INFORMATION
120 FACE DETECTION UNIT
130 FEATURE POINT EXTRACTION UNIT
140 REGISTRATION UNIT
150 AUTHENTICATION UNIT
200 AUTHENTICATION CONTROL APPARATUS
200a AUTHENTICATION CONTROL APPARATUS
200b AUTHENTICATION CONTROL APPARATUS
200c AUTHENTICATION CONTROL APPARATUS
210 STORAGE UNIT
211 PROGRAM
211a PROGRAM
211b PROGRAM
211c PROGRAM
212 DISPLAY MODE INFORMATION
212a DISPLAY MODE INFORMATION
2121 FACE AUTHENTICATION RESULT
2122 DETERMINATION RESULT
2123 DECORATION INFORMATION
2124 ATTRIBUTE
213 USER MANAGEMENT INFORMATION
213b USER MANAGEMENT INFORMATION
2131 USER ID
2132 ATTRIBUTE
2133 DISPLAY NAME
2134 BODY SURFACE TEMPERATURE HISTORY
214 FACE INFORMATION DB
2141 USER ID
2142 FACE FEATURE INFORMATION
220 MEMORY
230 COMMUNICATION UNIT
240 CONTROL UNIT
241 ACQUISITION UNIT
241a ACQUISITION UNIT
241b ACQUISITION UNIT
242 AUTHENTICATION CONTROL UNIT
242c AUTHENTICATION CONTROL UNIT
243 DETERMINATION UNIT
243b DETERMINATION UNIT
244 DECISION UNIT
244a DECISION UNIT
244b DECISION UNIT
245 OUTPUT UNIT
245a OUTPUT UNIT
300 THERMAL CAMERA
400 MIRROR SIGNAGE
411 DISPLAY INFORMATION
412 DISPLAY INFORMATION
413 DECORATION INFORMATION
421 DISPLAY INFORMATION
422 DISPLAY INFORMATION
423 DECORATION INFORMATION
431 DISPLAY INFORMATION
432 DISPLAY INFORMATION
433 DECORATION INFORMATION
441 DISPLAY INFORMATION
442 DISPLAY INFORMATION
443 DISPLAY INFORMATION
444 DECORATION INFORMATION
445 DISPLAY INFORMATION
452 DISPLAY INFORMATION
453 DISPLAY INFORMATION
455 DISPLAY INFORMATION
N NETWORK
U1 USER
U2 USER
U3 USER

What is claimed is:

1. An authentication control apparatus comprising:
at least one storage device configured to store instructions; and
at least one processor configured to execute the instructions to:
acquire an image obtained by imaging a body including a face of an authentication target person;
acquire a face authentication result obtained using face feature information of a plurality of persons and face feature information extracted from the image;
acquire a body surface temperature measured from the authentication target person;
decide a display mode associated to a combination of the face authentication result and the body surface temperature; and
output the image to a predetermined display device according to the decided display mode.

2. The authentication control apparatus according to claim 1,
wherein the at least one processor is further configured to execute the instructions to:
determine whether or not the acquired body surface temperature is lower than a predetermined value,
decide, as the display mode, decoration information associated to a combination of the face authentication result and a body surface temperature determination result, and
output the image in such a way as to display the decided decoration information at a position corresponding to a region of the authentication target person in the image.

3. The authentication control apparatus according to claim 2, wherein the at least one processor is further configured to execute the instructions to:
decide a line type or a color associated to the combination of the face authentication result and the body surface temperature determination result as the decoration information, and
output the image in such a way that a line of the decided line type or color surrounds the region of the authentication target person in the image.

4. The authentication control apparatus according to claim 2,
wherein the at least one processor is further configured to execute the instructions to:
output the image in such a way that the decided decoration information is superimposed on the region of the authentication target person in the image.

5. The authentication control apparatus according to claim 2, wherein the at least one processor is further configured to execute the instructions to:
decide the predetermined value based on a body surface temperature history of the authentication target person, and
perform the determination based on the decided predetermined value.

6. The authentication control apparatus according to claim 1, wherein the at least one processor is further configured to execute the instructions to:
decide display information associated to at least one of the face authentication result or the body surface temperature as the display mode, and
output the image in such a way as to add and display the decided display information at a position corresponding to the region of the authentication target person in the image.

7. The authentication control apparatus according to claim 6,
wherein the display information is an indication of the face authentication result and the body surface temperature.

8. The authentication control apparatus according to claim 1, wherein the at least one processor is further configured to execute the instructions to:
acquire an attribute of the authentication target person based on the face authentication result, and
decide the display mode further in accordance with the acquired attribute.

9. The authentication control apparatus according to claim 1,
wherein the at least one processor is further configured to execute the instructions to:
acquire the body surface temperature in a case where the face authentication result indicates success of face authentication.

10. The authentication control apparatus according to claim 1,
wherein the predetermined display device is a mirror signage.

11. The authentication control apparatus according to claim 1,
wherein the at least one processor is further configured to execute the instructions to:
cause an authentication apparatus that stores the face feature information of the plurality of persons to perform the face authentication using the face feature information extracted from the image, and acquire the face authentication result from the authentication apparatus.

12. The authentication control apparatus according to claim 1, wherein the at least one processor is further configured to execute the instructions to:
store the face feature information of the plurality of persons in the at least one storage device, and
acquire the face authentication result by performing the face authentication by collating the face feature information of the plurality of persons with the face feature information extracted from the image.

13. An authentication control system comprising:
an imaging device;
a body surface temperature measurement device;
a display device; and
an authentication control apparatus,
wherein the authentication control apparatus comprises:
at least one storage device configured to store instructions; and
at least one processor configured to execute the instructions to:
acquire an image obtained by imaging, by the imaging device, a body including a face of an authentication target person;
acquire a face authentication result obtained using face feature information of a plurality of persons and face feature information extracted from the image;
acquire a body surface temperature of the authentication target person measured by the measurement device;
decide a display mode associated to a combination of the face authentication result and the body surface temperature; and
output the image to the display device according to the decided display mode.

14. The authentication control system according to claim 13, wherein the at least one processor is further configured to execute the instructions to:
determine whether or not the acquired body surface temperature is lower than a predetermined value,
decide, as the display mode, decoration information associated to a combination of the face authentication result and a body surface temperature determination result, and
output the image in such a way as to display the decided decoration information at a position corresponding to a region of the authentication target person in the image.

15. An authentication control method performed by a computer, the authentication control method comprising:
acquiring an image obtained by imaging a body including a face of an authentication target person;
acquiring a face authentication result obtained using face feature information of a plurality of persons and face feature information extracted from the image;
acquiring a body surface temperature measured from the authentication target person;
deciding a display mode associated to a combination of the face authentication result and the body surface temperature; and
outputting the image to a predetermined display device according to the decided display mode.

16. A non-transitory computer-readable medium storing an authentication control program that causes a computer to perform:
image acquisition processing of acquiring an image obtained by imaging a body including a face of an authentication target person;
authentication control processing of acquiring a face authentication result obtained using face feature information of a plurality of persons and face feature information extracted from the image;
acquisition processing of acquiring a body surface temperature measured from the authentication target person;
selection processing of deciding a display mode associated to a combination of the face authentication result and the body surface temperature; and
output processing of outputting the image to a predetermined display device according to the decided display mode.
